(19) United States
(12) Patent Application Publication
(10) Pub. No.: US 2019/0160619 A1
(43) Pub. Date: May 30, 2019

(54) Tool State Detection Method of Machine Tool and System Thereof

(71) Applicant: Techmark Precision Instrument Co. Ltd., Dongguan City (CN)

(72) Inventors: WEI-HSIANG LIN, New Taipei City (TW); SHUN-YANG CHEN, New Taipei City (TW); JYH-CHENG JENG, Taipei City (TW)

(21) Appl. No.: 16/199,977

(22) Filed: Nov. 26, 2018

(30) Foreign Application Priority Data
Nov. 28, 2017 (TW) 106141467

(51) Int. Cl. B23Q 17/09

(52) U.S. Cl. CPC B23Q 17/0961; B23Q 2717/00; B23Q 17/0971; B23Q 17/0966

(57) ABSTRACT

A tool state detection system and a method thereof are provided, for instantaneously analyzing a state of a tool by sensing influence of the tool on a machine spindle or working environment during execution of a process, without the need of extra time for detecting the tool, thereby effectively controlling the current quality status of the tool to improve the efficiency of the tool.

### CROSS-REFERENCE TO RELATED APPLICATIONS

This application claims the priority of Republic of China Patent Application No. 106141467 filed on Nov. 28, 2017, respectively, in the State Intellectual Property Office of the R.O.C., the disclosure of which is incorporated herein by reference.

### BACKGROUND OF THE INVENTION

### Field of the Invention

The present invention relates to equipment detection technology, and more particularly, to a tool state detection system and a method thereof.

### Descriptions of the Related Art

Manpower, raw materials and processing consumables are key factors directly related to costs of the current machining industry, and the use of tools is most closely related to the above three. At present, the life of tools is mainly determined by manual experience in terms of tool replacement and use angle. This method is quite subjective, and the conditions set by manual experience values may not match actual processing conditions. What would undoubtedly happen is the life of tools being shortened in order to assure the processing quality. That is, tools would be replaced more frequently to avoid overuse of the tools which deteriorates the quality. This definitely increases the frequency of tool replacement and the number of tools being used, thereby making personnel costs and tool costs undesirably rise. On the contrary, if it is to reduce those costs, the life of tools must be prolonged to make the tools not so frequently replaced, which however raises the risk of deteriorating the processing quality. It is thus clear that, costs of the machining industry can be significantly reduced to improve competitiveness by effectively controlling the current quality status of tools and improving the tool efficiency.

Conventional tool quality detection technology primarily involves direct detection that uses optical and contact methods to detect the appearance of tools. In the direct detection method, however, any foreign substance interference in a processing environment would increase difficulty of detection and easily cause errors in detection results. For example, cutting oil is normally sprayed on the tools during a milling process, and any residue of the cutting oil on the tools would make the optical detection method more difficult to proceed. Further in the milling process, some iron filings would wind or stick onto the tools and lead to errors in the contact detection method.

Moreover, there are indirect tool detection methods by indirectly contacting the tools, for example, measuring their vibration signals or sound signals. This measurement method however encounters difficult problems in analyzing data. It is because there are too many frequency features in audio and vibration frequencies, making it impossible to determine quality difference of the tools by a single variable, and also because original features often change due to the change of processing conditions, a lot of time resources are required in finding the determining features for analyzing the data.

Moreover, all the above detection methods are performed offline for detecting or determining the status of tools, wherein offline means that those methods are not obtaining instantaneous information about the tools at the time of processing workpieces but use extra time to do the detection. This results in increase of product processing time, and more frequent detection also increases the processing time. Efficiency of production capacity is most directly related to costs on a production line, and thus how to achieve greatest production capacity within the shortest period of time is a key to reduce the costs. Any increase in time costs for detecting the tools is not desirable, and failure in quality control caused by reducing the frequency of detecting the tools is also not desirable.

Therefore, how to provide a tool state detection technique, which can solve all the above problems in the conventional technology, is an important task in the art.

### SUMMARY OF THE INVENTION

In view of the shortages of prior arts mentioned above, the mainly object of the present invention are to provide a tool state detection system and a method thereof for the tool use state being detected anytime during a processing procedure.

Another object of the present invention are to provide a tool state detection system and a method thereof for effectively improving efficiency of the tool and processing quality of workpieces.

For the objects said above and for other objects, the first embodiment of the invention provides a tool state detection system applicable to a tool machine, for detecting a state of a tool of a machine spindle, the tool state detection system including: a sensor mounted on the machine spindle, for sensing influence of the tool on the machine spindle when the tool performs a process, so as to generate sensing result of time domain information, the sensing result of time domain information including good-product sensing result of time domain information, wherein the good-product sensing result of time domain information is generated by the sensor sensing influence of the tool on the machine spindle when the tool is a good product and performs the process;

a good-product feature space model building module for performing transformation between time domain and frequency domain on the good-product sensing result of time domain information to obtain good-product sensing result of frequency domain information, and for collecting representative main good-product features in the good-product sensing result of frequency domain information to form a good-product feature space model in a second frequency domain space; and a state analysis module for instantaneously performing transformation between time domain and frequency domain on the sensing result of time domain information when the tool performs the process so as to obtain first sensing result of frequency domain information in a first frequency domain space, and for transforming the first sensing result of frequency domain information by the good-product feature space model into second sensing result of frequency domain information in the second frequency domain space, and for transforming the second sensing result of frequency domain information by the good-product feature space model into third sensing result of frequency domain information in the first frequency domain space, wherein the first sensing result of frequency domain information is compared with the third sensing result of frequency domain information for difference, so as to generate a tool state index for use in instantaneously analyzing the state of the tool.

Preferably, in the tool state detection system said above, wherein the sensor is at least one of acceleration sensor, strain sensor, stress sensor and current sensor.

The second embodiment of the present invention provides a tool state detection system applicable to a tool machine, for detecting a state of a tool in a working environment where the tool performs a process, the tool state detection system including: a sensor mounted on the tool machine, for sensing influence of the tool on the working environment when the tool performs the process, so as to generate sensing result of time domain information, the sensing result of time domain information including good-product sensing result of time domain information, wherein the good-product sensing result of time domain information is generated by the sensor sensing influence of the tool on the working environment when the tool is a good product and performs the process; a good-product feature space model building module for performing transformation between time domain and frequency domain on the good-product sensing result of time domain information to obtain good-product sensing result of frequency domain information, and for collecting representative main good-product features in the good-product sensing result of frequency domain information to form a good-product feature space model in a second frequency domain space; and a state analysis module for instantaneously performing transformation between time domain and frequency domain on the sensing result of time domain information when the tool performs the process so as to obtain first sensing result of frequency domain information in a first frequency domain space, and for transforming the first sensing result of frequency domain information by the good-product feature space model into second sensing result of frequency domain information in the second frequency domain space, and for transforming the second sensing result of frequency domain information by the good-product feature space model into third sensing result of frequency domain information in the first frequency domain space, wherein the first sensing result of frequency domain information is compared with the third sensing result of frequency domain information for difference, so as to generate a tool state index for use in instantaneously analyzing the state of the tool.

Preferably, in the tool state detection system said above, the sensor is at least one of sound sensor, light sensor and color sensor.

Preferably, in the tool state detection system of the first and second embodiments, when a blade of the tool periodically touches a workpiece, the representative main good-product features in the good-product sensing result of frequency domain information and the first sensing result of frequency domain information obtained by the state analysis module, are retrieved from appropriate frequency section information of frequency multiples in distribution ranges related to a rotating speed of the tool performing the process; when the blade of the tool continuously touches the workpiece, the representative main good-product features in the good-product sensing result of frequency domain information and the first sensing result of frequency domain information obtained by the state analysis module, are retrieved from all frequency sections in the distribution ranges related to the rotating speed of the tool performing the process.

Preferably, in the tool state detection system of the first and second embodiments, the main good-product features are represented as second frequency domain main good-product features in the second frequency domain space, the second frequency domain space including a main axis and a secondary axis of an orthogonal relation, wherein the second frequency domain main good-product features have projection on the main axis located in a first distribution range, and have projection on the secondary axis located in a second distribution range, wherein the first distribution range is larger than the second distribution range, and the second frequency domain main good-product features are more obvious on the main axis than the secondary axis, so as to allow the good-product sensing result of frequency domain information to form the good-product feature space model based on the main axis in the second frequency domain space.

Preferably, in the tool state detection system of the first and second embodiments, in the good-product feature space model, representative ones in the second frequency domain main good-product features are retained, and non-representative ones in the second frequency domain main good-product features are deleted.

Preferably, in the tool state detection system of the first and second embodiments, tool is a tool for performing a rotary cutting process, or a tool for performing a linear cutting process.

Moreover, the present invention further provides a tool state detection method, for detecting a state of a tool of a machine spindle in a working environment where the tool performs a process, the tool state detection method including the steps of: sensing influence of the tool on the machine spindle or working environment when the tool is performing the process, so as to generate sensing result of time domain information, the sensing result of time domain information including good-product sensing result of time domain information, wherein the good-product sensing result of time domain information is generated by a sensor sensing influence of the tool on the machine spindle or working environment when the tool is a good product and is performing the process; performing transformation between time domain and frequency domain on the good-product sensing result of time domain information to obtain good-product sensing result of frequency domain information, and collecting representative main good-product features in the good-product sensing result of frequency domain information to form a good-product feature space model in a second frequency domain space; and instantaneously performing transformation between time domain and frequency domain on the sensing result of time domain information when the tool is performing the process, so as to obtain first sensing result of frequency domain information in a first frequency domain space, and transforming the first sensing result of frequency domain information by the good-product feature space model into second sensing result of frequency domain information in the second frequency domain space, and then transforming the second sensing result of frequency domain information by the good-product feature space model into third sensing result of frequency domain information in the first frequency domain space, and then comparing the first sensing result of frequency domain information and the third sensing result of frequency domain information for difference so as to generate a tool state index to instantaneously analyze the state of the tool.

In comparison to prior arts, the present invention is to provide a tool state detection system and a method thereof by sensing influence of a tool on a machine spindle or working environment during execution of a process to instantaneously generate sensing result of time domain information, and by using a good-product feature space model to perform transformation between time domain and frequency domain on the sensing result of time domain information so as to obtain first sensing result of frequency domain information and third sensing result of frequency domain information in a first frequency domain space, such that the first sensing result of frequency domain information is compared with the third sensing result of frequency domain information for any difference therebetween to instantaneously analyze a use state of the tool. In the invention, the tool use state can thereby be detected anytime during a processing procedure, without using extra time for detection and thus reducing the tool detection costs. Moreover, the detection results of the tool use state obtained in the invention have high accuracy, thereby effectively improving efficiency of the tool and processing quality of workpieces.

### BRIEF DESCRIPTION OF THE DRAWINGS

The above and other aspects, feature and other advantages of the present invention will be more clearly understood from the following detailed description taken in conjunction with the accompanying drawings, in which:

FIG. 1A is a system block diagram of a tool state detection system according to a first preferred embodiment of the invention.

FIGS. 1B to 1C are use state diagrams of the tool state detection system shown in FIG. 1A.

FIG. 2A is a system block diagram of a tool state detection system according to a second preferred embodiment of the invention.

FIG. 2B is a use state diagram of the tool state detection system shown in FIG. 2A.

FIG. 3 is a flow diagram of a tool state detection method according to the invention.

FIG. 4 is a schematic diagram showing a milling process.

FIG. 5 is a schematic diagram showing a drilling, tapping or reaming process.

FIG. 6 is a schematic diagram showing sensed of time domain information according to the invention.

FIG. 7 is a schematic diagram showing the sensed of time domain information being transformed into of frequency domain information according to the invention.

FIG. 8 is a schematic diagram showing a good-product feature space model according to the invention.

### DETAILED DESCRIPTION OF THE PREFERRED EMBODIMENT

Embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like components.

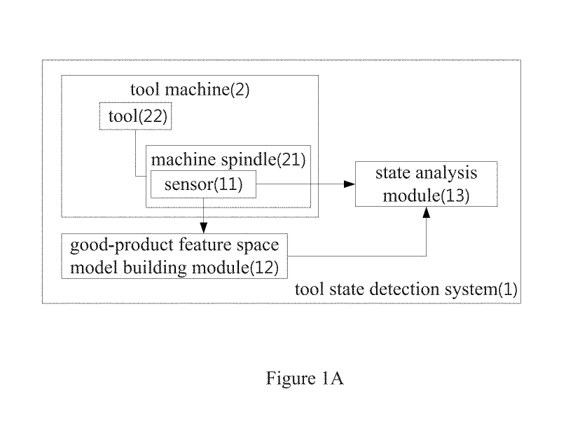

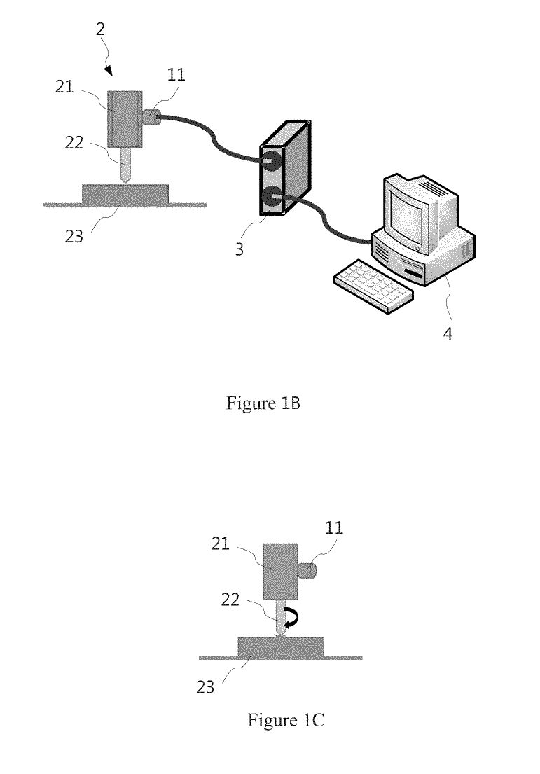

A tool state detection system according to the invention is used for detecting a tool use state of a machine spindle of a machine tool. FIGS. 1A to 1C are architectural schematic diagrams showing the tool state detection system according to a first preferred embodiment of the invention. The tool state detection system 1 of the invention is applicable to a machining tool machine 2 in a machining process such as drilling, tapping, reaming, milling or grinding, for instantaneously detecting if a tool 22 is in an abnormal status. The abnormal status of the tool 22 is for example, tool abrasion, tool breaking, tool jamming or abrasion of tool blade, etc. In the invention, primarily a state of an initial (normal) process procedure serves as a difference comparison target. Then, when a same processing procedure is repeated, a single comparison index is instantaneously outputted during the processing procedure, for use in determining whether this processing procedure is in an abnormal state, so as to instantaneously determine if the tool 22 is having an abnormal use state. The invention is thereby applicable to state detection of the tool 22 repeatedly performing a single processing procedure on a production line. It should be noted that, the above comparison index is also flexibly used in instantaneously monitoring abnormal state warning or determining tool quality.

Particularly according to the invention, when the equipment repeatedly performs a same operating procedure, a normal operating state serves as a difference comparison target, and then during the same operating procedure being repeated, a single comparison index is instantaneously outputted for use in determining whether the equipment is in an abnormal operating state, so as to instantaneously detect if the equipment is having an abnormal use state. Thus, the invention is also applicable to equipment detection in various fields, such as mechanical arms, robots, automated machines, motors, wind turbines, engines (for vehicles, aircrafts) and so on.

As shown in FIG. 1B, the tool machine 2 has a machine spindle 21, and the tool 22 is mounted on the machine spindle 21 and can be driven by the machine spindle 21 to rotate downwardly as shown in FIG. 1C to perform a machining process (such as cutting) on a workpiece 23. The tool 22 is for example, a tool for performing a rotary cutting process, or a tool for repeatedly executing a same reciprocating linear cutting process.

Referring to FIG. 1A, the tool state detection system 1 in this embodiment includes a sensor 11, a good-product feature space model building module 12, and a state analysis module 13.

The sensor 11 is for example, acceleration sensor, strain sensor, stress sensor, voltage sensor or any other sensor that may sense influence of the tool 22 on the machine spindle 21 during execution of a process. The sensor 11 is selectively mounted on the machine spindle 21, and is not in direct contact with the tool 22 to avoid damage thereof The sensor 11 is used to sense influence of the tool 22 on the machine spindle 21 during execution of a process, and accordingly generates sensing result of time domain information for indirectly sensing the use status of the tool 22. The tool 22 should be a good product having less abrasion during initial use. The sensor 11 can sense the influence of the good-product tool 22 on the machine spindle 21 during an initial cutting process being performed by the tool 22, to generate sensing result of time domain information in the time domain to form good-product sensing result of time domain information of the tool 22. Further, there may be provided a plurality of sensors 11 to sense the influence of the good-product tool 22 on the machine spindle 21, for example in an axial direction (such as X, Y, Z axis) of the machine spindle 21 or on various physical parameters of the machine spindle 21, in order to generate more complete and accurate good-product sensing result of time domain information.

Then, referring to FIG. 1B, the sensor 11 communicates with and is connected to a sensor interface circuit and signal processor 3 by a signal line. The sensor interface circuit and signal processor 3 further communicates with and is connected to a computer 4 by a signal line, and processes the sensing result of time domain information generated from the sensor 11 and transmits the processed information to the computer 4. Then the computer 4 executes preset operation formula and operation flow to analyze the received sensing result of time domain information, so as to accordingly determine the current use state of the tool 22.

The following description illustrates a preferred embodiment of the invention.

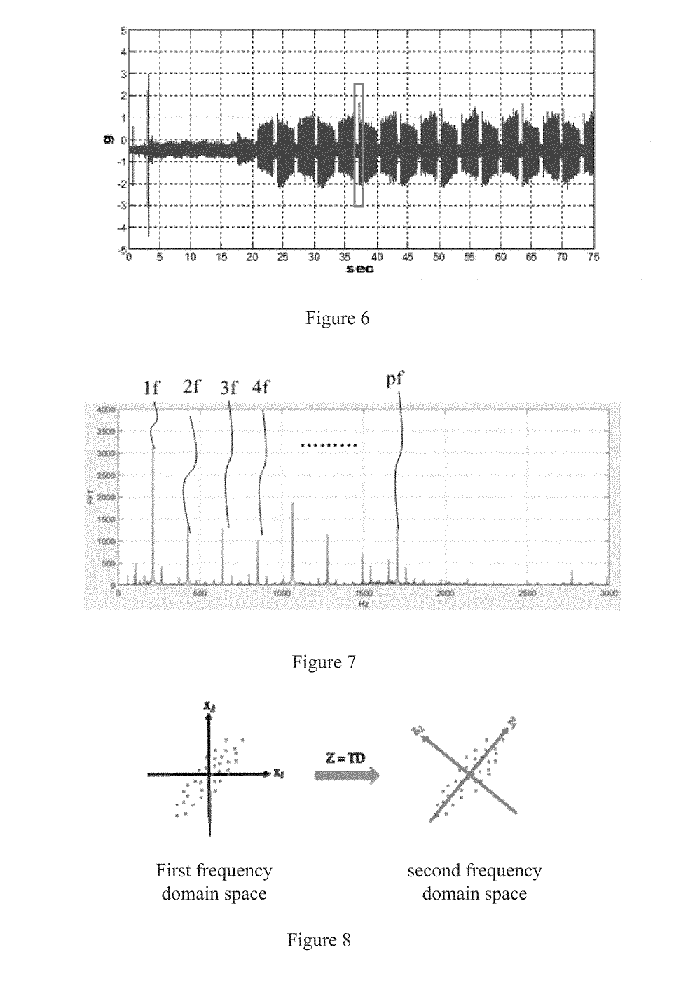

As shown in FIG. 1C, the sensor 11 is an acceleration sensor (that is, acceleration gauge) mounted on the machine spindle 21. When the machine spindle 21 drives the tool 22 to rotate and perform a cutting process on the workpiece 23, the workpiece 23 generates resistance against the tool 22 and makes it vibrate, thereby making the machine spindle 21, which drives the tool 22 to rotate, also vibrate. In the meantime, the sensor 11 mounted on the machine spindle 21 can collect current vibration acceleration signal waveform of the machine spindle 21 in the time domain to indirectly sense physical parameters of vibration of the tool 22. Thereby, subsequently sensing result of time domain information can be generated from a plurality of sections in the collected vibration acceleration signal waveform. In FIG. 6, the framed area shows one of the plurality of sections in the vibration acceleration signal waveform.

Then, Fourier Transform (FFT) can be applied to the generated sensing result of time domain information to transform each of the sections in the vibration acceleration signal waveform collected in the time domain into of frequency domain information, so as to expand frequency components of each of the sections in the frequency domain, as shown in FIG. 7. Due to resonance effect, in the expanded frequency components of each of the sections in the frequency domain, larger data values apparently appear close to multiples of the tool's rotational frequency f (that is, 1f, 2f, 3f, . . . shown in FIG. 7), and these data values can be used in determining the tendency of the tool 22 influencing the machine spindle 21 when a process is performed by the tool 22. It should be noted that, as there is usually a difference between a predetermined rotating speed and an actual rotating speed of the tool 22 during the cutting process, practically an error range at a particular multiple of the rotational frequency is allowable according to the difference in rotating speed, and any data value can be retrieved within the allowable error range, wherein a maximum data value retrieved within the allowable error range serves as a corresponding data value to the particular multiple of the rotational frequency.

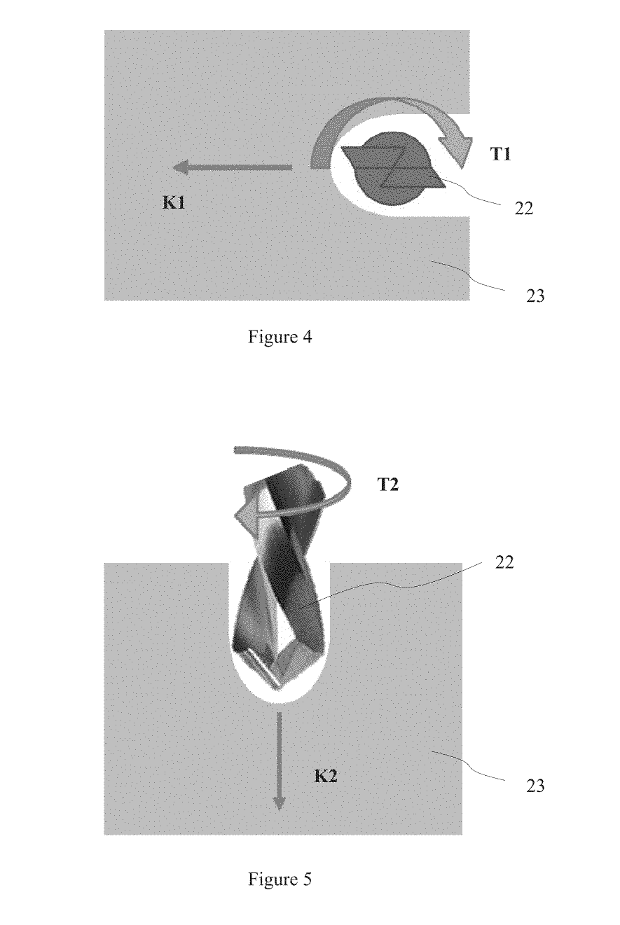

More particularly, when a milling process is executed, as shown in FIG. 4, the tool 22 rotates in T1 direction and performs machining towards K1 direction, during which the tool 22 has its blade periodically cutting the workpiece, that is, the blade touches the workpiece at a fixed cycle, wherein the fixed cycle is related to the rotating speed of the tool. In this case, most of feature signals that may indicate the state of the tool would be shown at frequency multiples of the rotating speed of the tool. This means a status of the tool can be analyzed according to suitable frequency band information of frequency multiples in a distribution range related to the rotating speed of the tool performing the process.

As shown in FIG. 5, however, when a drilling, tapping or reaming process is executed, the tool 22 rotates in T2 direction and performs machining towards K2 direction, during which the blade of the tool continuously cuts the workpiece, that is, the blade of the tool continuously touches the workpiece. In this case, the feature signals that may indicate the state of the tool are not necessarily shown at the frequency multiples of the rotating speed of the tool, such that a status of the tool must be analyzed according to suitable information in all frequency bands (including bands of frequency multiples and other frequency bands) in a distribution range related to the rotating speed of the tool performing the process.

Then, data values related to multiples of the tool's rotational frequency f (1f, 2f, 3f, . . . ) in the expanded frequency components of FIG. 7 are used as analytical observation variables. Data i can be expressed as:

$${x}_{i} = [ \begin{matrix}{x}_{1 i} \\ {x}_{2 i} \\ ⋮ \\ {x}_{pi}\end{matrix} ]$$

wherein, xᵢ represents frequency component of section i in the vibration acceleration signal waveform; x₁ᵢ represents data value (dimension 1: observation variable 1) of frequency multiple 1f of section i in the vibration acceleration signal waveform; x₂ᵢ represents data value (dimension 2: observation variable 2) of frequency multiple 2f of section i in the vibration acceleration signal waveform; xₚᵢ represents data value (dimension p: observation variable p) of frequency multiple pf of section i in the vibration acceleration signal waveform.

The good-product feature space model building module 12 is used for performing transformation between time domain and frequency domain on the good-product sensing result of time domain information generated by the sensor 11 to form good-product sensing result of frequency domain information in a first frequency domain space, and for collecting representative main good-product features from the good-product sensing result of frequency domain information to build a good-product feature space model, for example, in a second frequency domain space.

Selectively, the representative main good-product features in the good-product sensing result of frequency domain information are obtained at frequency multiples (such as 1f, 2f, 3f, . . . pf in FIG. 7) defined by the rotating speed of the tool 22 performing the cutting process.

Selectively, for the good-product feature space model building module 12, its difference comparison model building algorithm concept is as follows:

X below represents matrix of p×n dimensions, which means n records of (good-product) measurement data containing p observation variables:

$$X = [ \begin{matrix}{x}_{11} & {x}_{12} & … & {x}_{1 n} \\ {x}_{21} & {x}_{22} & … & {x}_{2 n} \\ ⋮ & ⋮ & ⋱ & ⋮ \\ {x}_{p 1} & {x}_{p 2} & … & {x}_{pn}\end{matrix} ]$$

wherein, [xⱼ₁ xⱼ₂ . . . xⱼₙ] is an observation variable j (j=1˜p); xᵢ below represents data i of matrix X:

$${x}_{i} = [ \begin{matrix}{x}_{1 i} \\ {x}_{2 i} \\ ⋮ \\ {x}_{pi}\end{matrix} ] , \\ i = 1 \sim n$$

x̅ⱼ below is an average of all data of an observation variable j:

$${\overline{x}}_{j} = \frac{1}{n} ( {x}_{j 1} + {x}_{j 2} + … + {x}_{jn} )$$

D below represents matrix of p×n dimensions, which means n records of (good-product) measurement data containing p observation variables, wherein the data deduct observation variable data averages:

$$\begin{matrix}D = [ \begin{matrix}{x}_{11} - {\overline{x}}_{1} & {x}_{12} - {\overline{x}}_{1} & … & {x}_{1 n} - {\overline{x}}_{1} \\ {x}_{21} - {\overline{x}}_{2} & {x}_{22} - {\overline{x}}_{2} & … & {x}_{2 n} - {\overline{x}}_{2} \\ ⋮ & ⋮ & ⋱ & ⋮ \\ {x}_{p 1} - {\overline{x}}_{p} & {x}_{p 2} - {\overline{x}}_{p} & … & {x}_{pn} - {\overline{x}}_{p}\end{matrix} ] \\ = [ \begin{matrix}{d}_{11} & {d}_{12} & … & {d}_{1 n} \\ {d}_{21} & {d}_{22} & … & {d}_{2 n} \\ ⋮ & ⋮ & ⋱ & ⋮ \\ {d}_{p 1} & {d}_{p 2} & … & {d}_{pn}\end{matrix} ]\end{matrix}$$

wherein, dᵢ below represents data i of matrix D:

$${d}_{i} = [ \begin{matrix}{d}_{1 i} \\ {d}_{2 i} \\ ⋮ \\ {d}_{pi}\end{matrix} ]$$

Selectively, the main good-product features are represented as second frequency domain main good-product features in the second frequency domain space, wherein the second frequency domain space includes a main axis and a secondary axis of an orthogonal relation. The second frequency domain main good-product features have projection on the main axis located in a first distribution range, and have projection on the secondary axis located in a second distribution range, wherein the first distribution range is larger than the second distribution range. This shows that the second frequency domain main good-product features are more obvious on the main axis than the secondary axis, such that the good-product sensing result of frequency domain information can be used to form the good-product feature space model based on the main axis in the second frequency domain space.

FIG. 8 is a two dimensional space schematic diagram of the good-product feature space mode, wherein, x₁, x₂ represent respectively a first initial axis and a second initial axis of first frequency domain main good-product features in the first frequency domain space; z₁, z₂ represent respectively a main axis and a secondary axis of second frequency domain main good-product features in the second frequency domain space.

T below represents transformation matrix, which transforms matrix D to a new frequency domain space to obtain matrix Z, that is, Z=TD. T below represents matrix of p×p dimensions:

$$T = [ \begin{matrix}{t}_{11} & {t}_{12} & … & {t}_{1 p} \\ {t}_{21} & {t}_{22} & … & {t}_{2 p} \\ ⋮ & ⋮ & ⋱ & ⋮ \\ {t}_{p 1} & {t}_{p 2} & … & {t}_{pp}\end{matrix} ]$$

Z below represents matrix of p×n dimensions, which is a result of transformation from matrix D by transformation matrix T:

$$Z = [ \begin{matrix}{z}_{11} & {z}_{12} & … & {z}_{1 n} \\ {z}_{21} & {z}_{22} & … & {z}_{2 n} \\ ⋮ & ⋮ & ⋱ & ⋮ \\ {z}_{p 1} & {z}_{p 2} & … & {z}_{pn}\end{matrix} ]$$

wherein, [zⱼ₁ zⱼ₂ . . . zⱼₙ] is an observation variable j (j=1˜p); zᵢ below represents data i of matrix Z:

$${z}_{i} = [ \begin{matrix}{z}_{1 i} \\ {z}_{2 i} \\ ⋮ \\ {z}_{pi}\end{matrix} ] , \\ i = 1 \sim n$$

Preferably, among the second frequency domain main good-product features in the good-product feature space model, representative ones are retained while non-representative ones are deleted. In particular, by means of a difference comparison model matrix building method with convergence of multiple variances (observation variables), the good-product feature space model building module 12 uses a transformation matrix that transforms spatial dimension directions, and removes dimension directions of small variances to form a difference comparison model matrix (that is, the good-product feature space model), which is detailed as follows:

in a new dimension space, variances Var₁, Var₂, . . . , Varₚ are obtained in each dimension axial direction for matrix Z, wherein variance Var₁ in the direction of new dimension 1 can be expressed as Var([z₁₁,z₁₂, . . . , z₁ₙ]) for matrix Z; variance Var₂ in the direction of new dimension 2 can be expressed as Var([z₂₁,z₂₂, . . . , z₂ₙ]) for matrix Z; variance Varₚ in the direction of new dimension p can be expressed as Var([zₚ₁,zₚ₂, . . . , zₚₙ]) for matrix Z;

the following is to place variances Var₁, Var₂, . . . , Varₚ in order from large to small and define them as S₁, S₂, . . . , Sₚ, that is, S₁ is the largest value among variances Var₁, Var₂, . . . , Varₚ:

$${Var}_{1} , {Var}_{2} , … , {Var}_{p} {s}_{1} , {s}_{2} , … , {s}_{p}$$

$${s}_{1} > {s}_{2} > … > {s}_{p}$$

Formula below illustrates percentage q % based on the extent of total variances of covered data, so as to selectively retain information in k dimension axial directions, that is, to retain representative ones while delete non-representative ones among the second frequency domain main good-product features, thereby making transformation matrix T become difference comparison model matrix M that serves as the good-product feature space model of the invention:

$$\frac{{\sum }_{i = 1}^{k} {s}_{i}}{{\sum }_{i = 1}^{p} {s}_{i }} = q \%$$

$$( k < p )$$

wherein, difference comparison model matrix M below is k×p matrix:

$$M = [ \begin{matrix}{m}_{11} & {m}_{12} & … & {m}_{1 p} \\ {m}_{21} & {m}_{22} & … & {m}_{2 p} \\ ⋮ & ⋮ & ⋱ & ⋮ \\ {m}_{k 1} & {m}_{k 2} & … & {m}_{kp}\end{matrix} ]$$

The state analysis module 13 is used for instantaneously performing transformation between time domain and frequency domain on the sensing result of time domain information when the tool 22 is executing a process, to form first sensing result of frequency domain information in the first frequency domain space. The first sensing result of frequency domain information is then transformed into second sensing result of frequency domain information in the second frequency domain space by means of the good-product feature space model. The second sensing result of frequency domain information is then transformed into third sensing result of frequency domain information in the first frequency domain space by means of the good-product feature space model. The first sensing result of frequency domain information is compared with the third sensing result of frequency domain information for difference, and according to the comparison result, a tool state index is generated for use in analyzing the state of the tool 22 instantaneously.

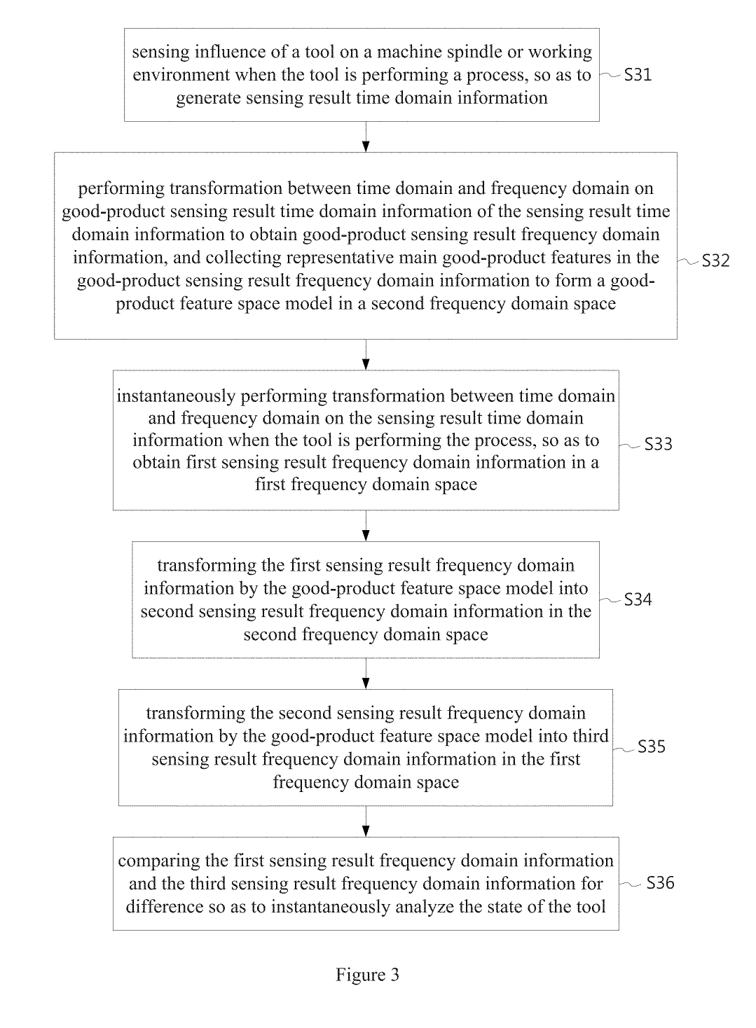

Selectively, the state analysis module 13 is used for performing an instantaneous difference comparison index calculation mechanism, by which every time only one set of data is collected, and this set of data is transformed by the difference comparison model matrix to a new dimension space and is then transformed back to the original dimension space by a transposed matrix of the difference comparison model matrix. Any difference before and after transformation of the set of data is used as a tool state index (that is, a difference comparison index) for instantaneously analyzing the state of the tool 22. Such calculation mechanism is to be further described below with reference to FIG. 3.

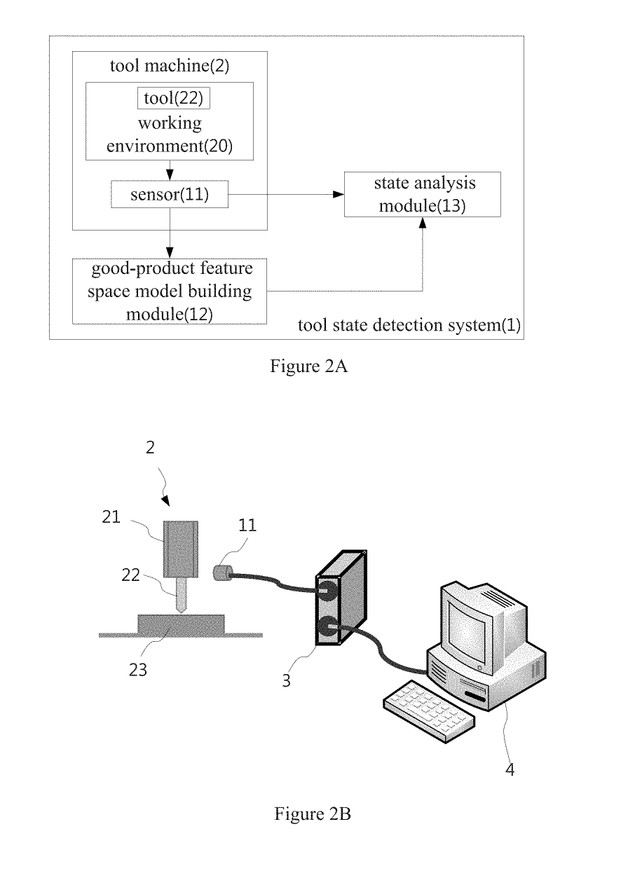

FIG. 2A and FIG. 2B are schematic diagrams of a tool state detection system according to a second preferred embodiment of the invention. The tool state detection system 1 in this embodiment differs from that of the first embodiment shown in FIG. 1A in that, the tool state detection system 1 is applied to a tool machine 2 for detecting a state of a tool in a working environment where the tool performs a process.

Referring to FIG. 2B, a sensor 11 is provided in the working environment where the tool machine 2 is located, and is not in contact with a machine spindle 21. The sensor 11 is used for sensing influence of the tool 22 on the working environment when a process is executed by the tool 22, so as to generate sensing result of time domain information. The sensor 11 is for example, sound sensor, light sensor, color sensor or any other type of sensor that can sense influence of the tool 22 on the working environment during a cutting process performed by the tool 22. Moreover, good-product feature space model building module 12 and state analysis module 13 in this embodiment are basically the same as those of the above first embodiment and thus not to be further described here.

FIG. 3 is a flow diagram of a tool state detection method according to the invention. This method of the invention is applied to a tool machine, for detecting a state of a tool of a machine spindle in a working environment when a process is performed by the tool. The steps of the method are detailed as follows.

Step S31 is to sense influence of the tool on the machine spindle or working environment when the tool is executing the process, so as to generate sensing result of time domain information. When the tool is in an initial use state (that is, the tool is in a good-product state), the generated sensing result of time domain information can serve as good-product sensing result of time domain information, that is, the good-product sensing result of time domain information is formed by a sensor sensing influence of the tool (considered as a good product) on the machine spindle or working environment when the tool is executing the process. In other words, the sensor 11 senses influence of the good-product tool 22 on the machine spindle 21 and generates sensing result of time domain information in the time domain to be used as good-product sensing result of time domain information.

Step S32 is to perform transformation between time domain and frequency domain on the good-product sensing result of time domain information to obtain good-product sensing result of frequency domain information, and to collect representative main good-product features in the good-product sensing result of frequency domain information to form a good-product feature space model in a second frequency domain space. Particularly, according to the above step that is executed by a good-product feature space model building module with a difference comparison model building concept, difference comparison model matrix M is obtained as follows and serves as the above good-product feature space model:

$$M = [ \begin{matrix}{m}_{11} & {m}_{12} & … & {m}_{1 p} \\ {m}_{21} & {m}_{22} & … & {m}_{2 p} \\ ⋮ & ⋮ & ⋱ & ⋮ \\ {m}_{k 1} & {m}_{k 2} & … & {m}_{kp}\end{matrix} ]$$

$$( difference comparison model matrix M )$$

Step S33 is to instantaneously perform transformation between time domain and frequency domain on the sensing result of time domain information when the tool is executing the process, so as to obtain first sensing result of frequency domain information d (as shown below) in a first frequency domain space.

$$x = [ \begin{matrix}{x}_{1} \\ {x}_{2} \\ ⋮ \\ {x}_{p}\end{matrix} ] d = [ \begin{matrix}{x}_{1} - {\overline{x}}_{1} \\ {x}_{2} - {\overline{x}}_{2} \\ ⋮ \\ {x}_{p} - {\overline{x}}_{p}\end{matrix} ] = [ \begin{matrix}{d}_{1} \\ {d}_{2} \\ ⋮ \\ {d}_{p}\end{matrix} ]$$

It should be noted that, when the tool's blade periodically touches a workpiece, the representative main good-product features in the good-product sensing result of frequency domain information and the first sensing result of frequency domain information obtained by a state analysis module, are retrieved from appropriate frequency section information of frequency multiples in distribution ranges related to a rotating speed of the tool that is executing the process. When the tool's blade continuously touches the workpiece, the representative main good-product features in the good-product sensing result of frequency domain information and the first sensing result of frequency domain information obtained by the state analysis module, are retrieved from all frequency sections in the distribution ranges related to the rotating speed of the tool that is executing the process.

Step S34 is to transform first sensing result of frequency domain information d by difference comparison model matrix M into second sensing result of frequency domain information y (as shown below) in the second frequency domain space.

$$Md = y = [ \begin{matrix}{y}_{1} \\ {y}_{2} \\ ⋮ \\ {y}_{k}\end{matrix} ]$$

In other words, difference comparison model matrix M is used to transform d generated in Step S33 into new observation variable y.

Step S35 is to transform second sensing result of frequency domain information y by transposed good-product feature space model (difference comparison model matrix) M^{T} into third sensing result of frequency domain information \hat{d} in the first frequency domain space, that is, transposed difference comparison model matrix M^{T} is used to further transform y into \hat{d}, as shown below.

$${M}^{T} y = \hat{d} = [ \begin{matrix}{\hat{d}}_{1} \\ {\hat{d}}_{2} \\ ⋮ \\ {\hat{d}}_{p}\end{matrix} ]$$

Step S36 is to compare any difference between first sensing result of frequency domain information d and third sensing result of frequency domain information \hat{d} to generate a difference comparison index serving as tool state index f_{d} that is for instantaneously analyzing the state of the tool, as shown below:

f_{d}=Σᵢ₌₁^{p}(dᵢ−\hat{d}ᵢ)²

wherein, f_{d} is tool state index, and larger its value, larger its difference from original standard (good-product feature space model) data group, which means the tool is in a state more different from good-product features and more likely to be abnormal.

It should be noted that, during operation of the tool state detection system of the invention, if more signals are collected and a plurality of tool state indexes f_{d} are generated, the tool state detection system would retrieve a median of the plurality of tool state indexes f_{d}, that is, the plurality of tool state indexes f_{d} are placed in order from large to small to exactly find a median thereof that becomes a representative tool state index f_{d}. In such case, if the tool state indexes f_{d} have drastic change in data and affect long-term trend determination, the risk of adversely affecting determination accuracy would be reduced.

Therefore, the tool state detection system and method of the invention use a sensor mounted on a machine spindle or tool machine to retrieve vibration signals generated by a tool when processing a workpiece and allow the vibration signals to be observation analysis data, thereby no need of extra time for detecting the tool, and desirably reducing costs of tool state detection.

Moreover, by establishing a specific detection method mechanism, a difference comparison model is found from a plurality of comparison features to become a good-product feature space model. According to this difference comparison model, a single difference comparison index can be calculated from data instantaneously collected during a processing procedure and serves as a tool state index, which is used for determining whether a use state of the tool is consistent with good-product features. This not only allows instantaneous comparison and determination during the processing procedure but also assures accuracy of detection results, thereby effectively improving efficiency of the tool and processing quality of the workpiece.

The examples above are only illustrative to explain principles and effects of the invention, but not to limit the invention. It will be apparent to those skilled in the art that modifications and variations can be made without departing from the scope of the invention. Therefore, the protection range of the rights of the invention should be as defined by the appended claims.

What is claimed is:

1. A tool state detection system applicable to a tool machine, for detecting a state of a tool of a machine spindle, the tool state detection system including:
a sensor mounted on the machine spindle, for sensing influence of the tool on the machine spindle when the tool performs a process, so as to generate sensing result of time domain information, the sensing result of time domain information including good-product sensing result of time domain information, wherein the good-product sensing result of time domain information is generated by the sensor sensing influence of the tool on the machine spindle when the tool is a good product and performs the process;
a good-product feature space model building module for performing transformation between time domain and frequency domain on the good-product sensing result of time domain information to obtain good-product sensing result of frequency domain information, and for collecting representative main good-product features in the good-product sensing result of frequency domain information to form a good-product feature space model in a second frequency domain space; and
a state analysis module for instantaneously performing transformation between time domain and frequency domain on the sensing result of time domain information when the tool performs the process so as to obtain first sensing result of frequency domain information in a first frequency domain space, and for transforming the first sensing result of frequency domain information by the good-product feature space model into second sensing result of frequency domain information in the second frequency domain space, and for transforming the second sensing result of frequency domain information by the good-product feature space model into third sensing result of frequency domain information in the first frequency domain space, wherein the first sensing result of frequency domain information is compared with the third sensing result of frequency domain information for difference, so as to generate a tool state index for use in instantaneously analyzing the state of the tool.

2. The tool state detection system according to claim 1, wherein the sensor is at least one of acceleration sensor, strain sensor, stress sensor and current sensor.

3. A tool state detection system applicable to a tool machine, for detecting a state of a tool in a working environment where the tool performs a process, the tool state detection system including:
a sensor mounted on the tool machine, for sensing influence of the tool on the working environment when the tool performs the process, so as to generate sensing result of time domain information, the sensing result of time domain information including good-product sensing result of time domain information, wherein the good-product sensing result of time domain information is generated by the sensor sensing influence of the tool on the working environment when the tool is a good product and performs the process;
a good-product feature space model building module for performing transformation between time domain and frequency domain on the good-product sensing result of time domain information to obtain good-product sensing result of frequency domain information, and for collecting representative main good-product features in the good-product sensing result of frequency domain information to form a good-product feature space model in a second frequency domain space; and
a state analysis module for instantaneously performing transformation between time domain and frequency domain on the sensing result of time domain information when the tool performs the process so as to obtain first sensing result of frequency domain information in a first frequency domain space, and for transforming the first sensing result of frequency domain information by the good-product feature space model into second sensing result of frequency domain information in the second frequency domain space, and for transforming the second sensing result of frequency domain information by the good-product feature space model into third sensing result of frequency domain information in the first frequency domain space, wherein the first sensing result of frequency domain information is compared with the third sensing result of frequency domain information for difference, so as to generate a tool state index for use in instantaneously analyzing the state of the tool.

4. The tool state detection system according to claim 3, wherein the sensor is at least one of sound sensor, light sensor and color sensor.

5. The tool state detection system according to claim 1, wherein when a blade of the tool periodically touches a workpiece, the representative main good-product features in the good-product sensing result of frequency domain information and the first sensing result of frequency domain information obtained by the state analysis module, are retrieved from appropriate frequency section information of frequency multiples in distribution ranges related to a rotating speed of the tool performing the process; when the blade of the tool continuously touches the workpiece, the representative main good-product features in the good-product sensing result of frequency domain information and the first sensing result of frequency domain information obtained by the state analysis module, are retrieved from all frequency sections in the distribution ranges related to the rotating speed of the tool performing the process.

6. The tool state detection system according to claim 3, wherein when a blade of the tool periodically touches a workpiece, the representative main good-product features in the good-product sensing result of frequency domain information and the first sensing result of frequency domain information obtained by the state analysis module, are retrieved from appropriate frequency section information of frequency multiples in distribution ranges related to a rotating speed of the tool performing the process; when the blade of the tool continuously touches the workpiece, the representative main good-product features in the good-product sensing result of frequency domain information and the first sensing result of frequency domain information obtained by the state analysis module, are retrieved from all frequency sections in the distribution ranges related to the rotating speed of the tool performing the process.

7. The tool state detection system according to claim 1, wherein the main good-product features are represented as second frequency domain main good-product features in the second frequency domain space, the second frequency domain space including a main axis and a secondary axis of an orthogonal relation, wherein the second frequency domain main good-product features have projection on the main axis located in a first distribution range, and have projection on the secondary axis located in a second distribution range, wherein the first distribution range is larger than the second distribution range, and the second frequency domain main good-product features are more obvious on the main axis than the secondary axis, so as to allow the good-product sensing result of frequency domain information to form the good-product feature space model based on the main axis in the second frequency domain space.

8. The tool state detection system according to claim 3, wherein the main good-product features are represented as second frequency domain main good-product features in the second frequency domain space, the second frequency domain space including a main axis and a secondary axis of an orthogonal relation, wherein the second frequency domain main good-product features have projection on the main axis located in a first distribution range, and have projection on the secondary axis located in a second distribution range, wherein the first distribution range is larger than the second distribution range, and the second frequency domain main good-product features are more obvious on the main axis than the secondary axis, so as to allow the good-product sensing result of frequency domain information to form the good-product feature space model based on the main axis in the second frequency domain space.

9. The tool state detection system according to claim 7, wherein in the good-product feature space model, representative ones in the second frequency domain main good-product features are retained, and non-representative ones in the second frequency domain main good-product features are deleted.

10. The tool state detection system according to claim 8, wherein in the good-product feature space model, representative ones in the second frequency domain main good-product features are retained, and non-representative ones in the second frequency domain main good-product features are deleted.

11. The tool state detection system according to claim 1, wherein tool is a tool for performing a rotary cutting process, or a tool for performing a linear cutting process.

12. The tool state detection system according to claim 3, wherein tool is a tool for performing a rotary cutting process, or a tool for performing a linear cutting process.

13. A tool state detection method applicable to a tool machine, for detecting a state of a tool of a machine spindle in a working environment where the tool performs a process, the tool state detection method including the steps of:
sensing influence of the tool on the machine spindle or working environment when the tool is performing the process, so as to generate sensing result of time domain information, the sensing result of time domain information including good-product sensing result of time domain information, wherein the good-product sensing result of time domain information is generated by a sensor sensing influence of the tool on the machine spindle or working environment when the tool is a good product and is performing the process;
performing transformation between time domain and frequency domain on the good-product sensing result of time domain information to obtain good-product sensing result of frequency domain information, and collecting representative main good-product features in the good-product sensing result of frequency domain information to form a good-product feature space model in a second frequency domain space; and
instantaneously performing transformation between time domain and frequency domain on the sensing result of time domain information when the tool is performing the process, so as to obtain first sensing result of frequency domain information in a first frequency domain space, and transforming the first sensing result of frequency domain information by the good-product feature space model into second sensing result of frequency domain information in the second frequency domain space, and then transforming the second sensing result of frequency domain information by the good-product feature space model into third sensing result of frequency domain information in the first frequency domain space, and then comparing the first sensing result of frequency domain information and the third sensing result of frequency domain information for difference so as to generate a tool state index to instantaneously analyze the state of the tool.
